(19) United States
(12) Patent Application Publication
(10) Pub. No.: US 2016/0052156 A1
(43) Pub. Date: Feb. 25, 2016

(54) Slicing Assembly

(71) Applicant: Daniel L. Wright, Beloit, WI (US)

(72) Inventor: Daniel L. Wright, Beloit, WI (US)

(21) Appl. No.: 14/928,676

(22) Filed: Oct. 30, 2015

Related U.S. Application Data
(63) Continuation-in-part of application No. 13/870,383, filed on Apr. 25, 2013.

(51) Int. Cl. B26D 3/28

(52) U.S. Cl. CPC B26D 3/283; B26D 2003/286

(57) ABSTRACT

A slicing assembly slices food into a plurality of slices of a selectable thickness in one motion. The assembly includes a base configured to be positioned on a support surface such that a food item is positionable on a top of the base. A selectable one of a plurality of cutting members is interchangeably coupled to the base such that the selected one of the cutting members is movably coupled to the top of the base. Each cutting member has a respective plurality of slicers. The slicers of each cutting member are uniquely spaced relative to each other cutting member wherein each cutting member is configured for slicing food in an associated thickness when a selected one of the cutting members is moved downwardly toward the base.

### BACKGROUND OF THE DISCLOSURE

1. Field of the Disclosure

The disclosure relates to slicing devices and more particularly pertains to a new slicing device for slicing food into a plurality of slices in one motion.

2. SUMMARY OF THE DISCLOSURE

An embodiment of the disclosure meets the needs presented above by generally comprising a base configured to be positioned on a support surface such that a food item is positionable on a top of the base. A selectable one of a plurality of cutting members is interchangeably coupled to the base such that the selected one of the cutting members is movably coupled to the top of the base. Each cutting member has a respective plurality of slicers. The slicers of each cutting member are uniquely spaced relative to each other cutting member wherein each cutting member is configured for slicing food in an associated thickness when a selected one of the cutting members is moved downwardly toward the base.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a slicing assembly according to an embodiment of the disclosure.

FIG. 2 is a top perspective view of an embodiment of the disclosure.

FIG. 3 is a right side view of an embodiment of the disclosure.

FIG. 4 is a front view of an embodiment of the disclosure.

FIG. 5 is a top view of an embodiment of the disclosure.

### DESCRIPTION OF THE PREFERRED EMBODIMENT

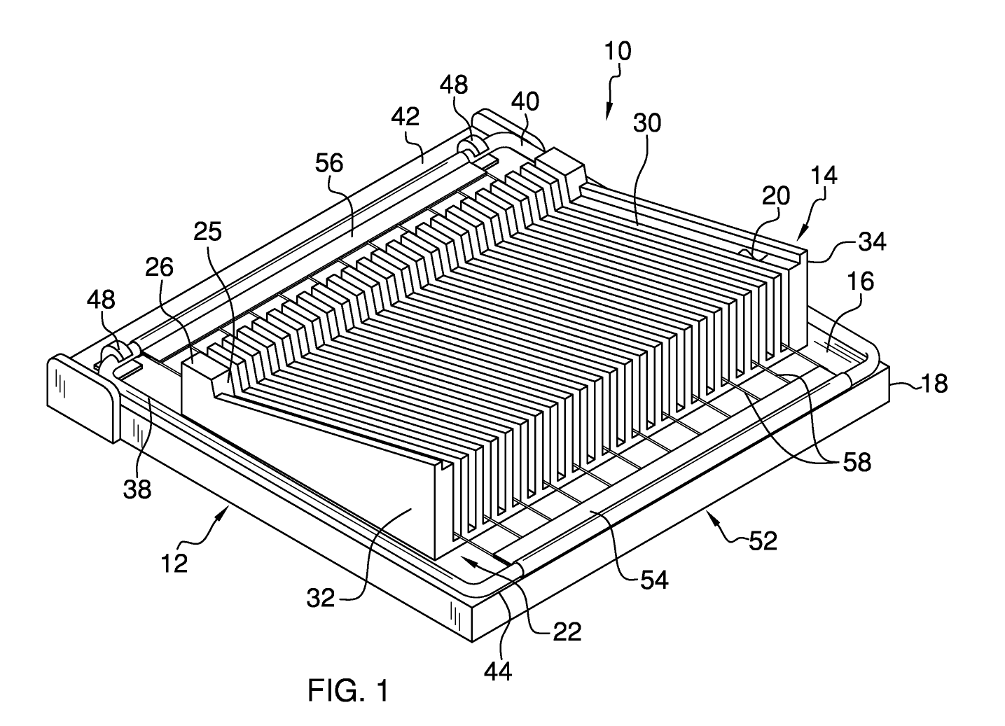

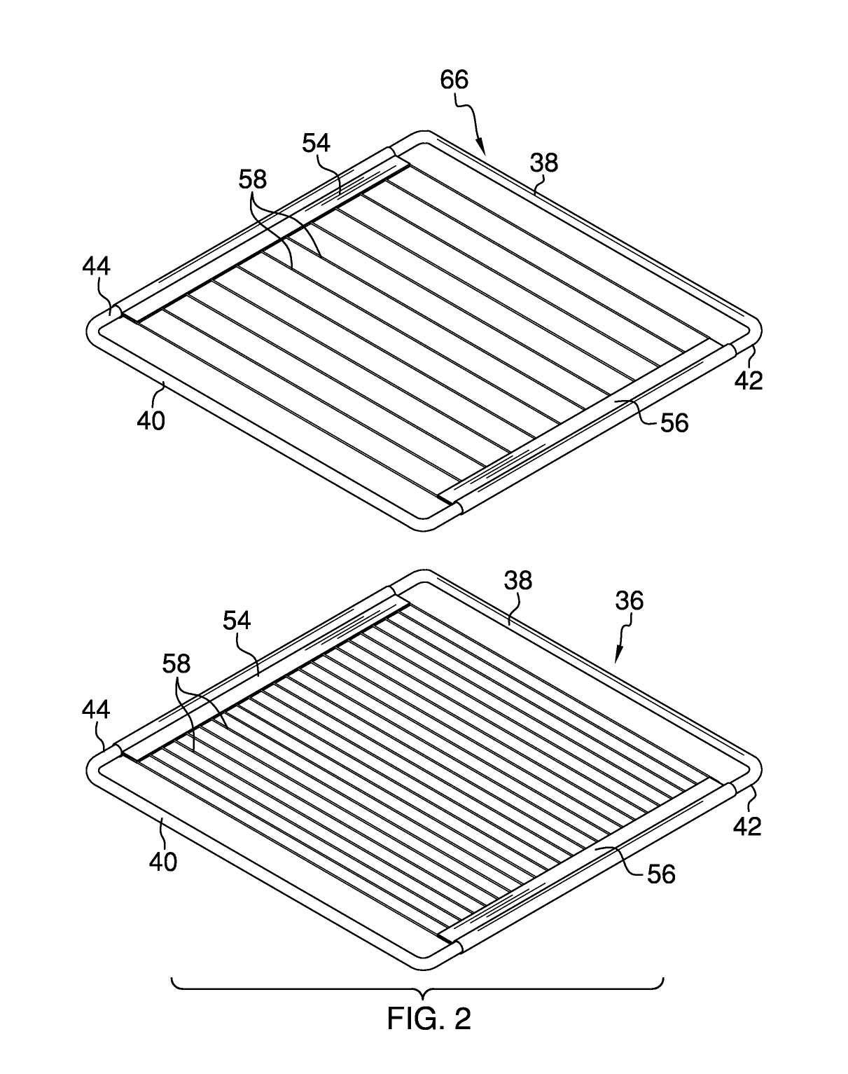

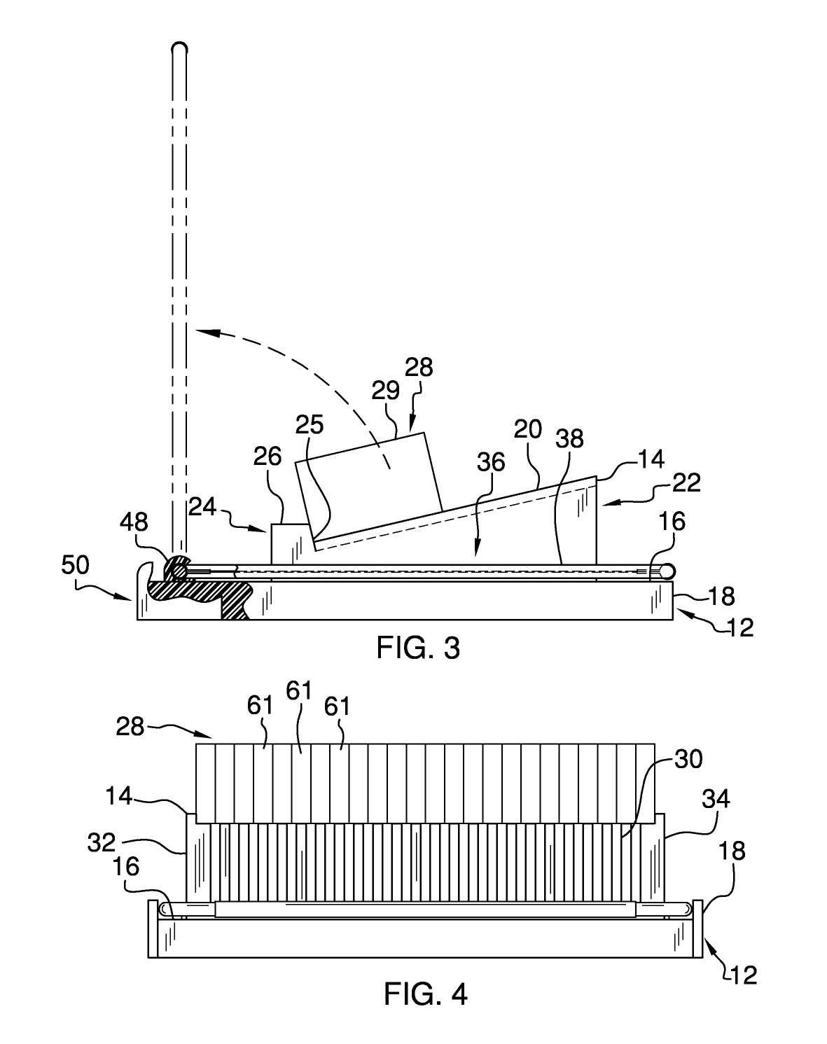

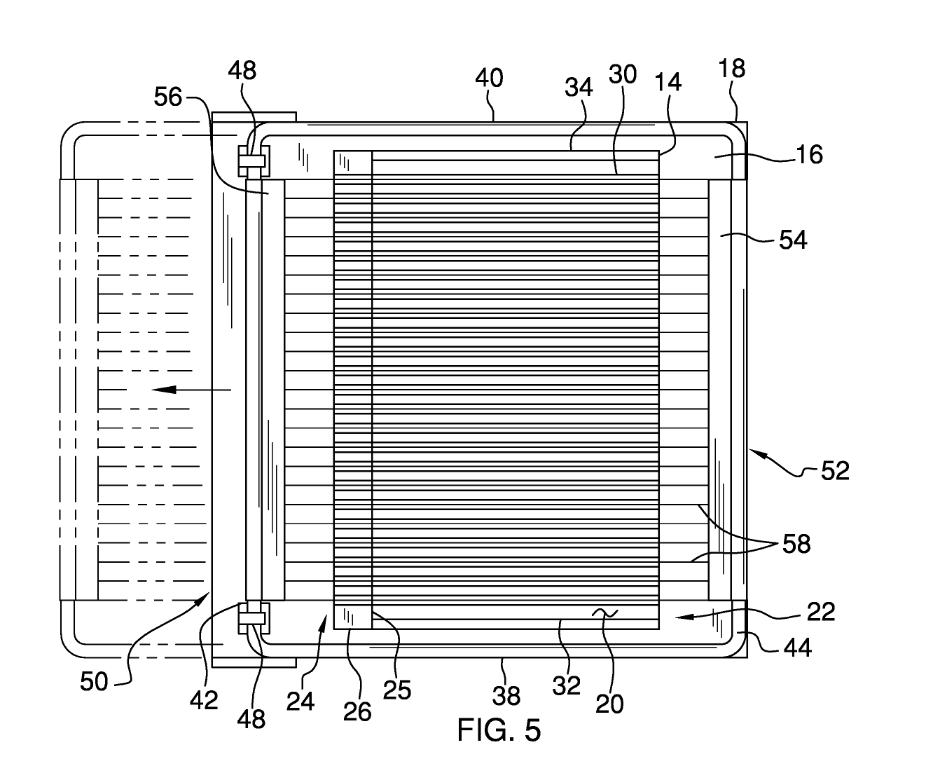

With reference now to the drawings, and in particular to FIGS. 1 through 5 thereof, a new slicing device embodying the principles and concepts of an embodiment of the disclosure and generally designated by the reference numeral 10 will be described.

As best illustrated in FIGS. 1 through 5, the slicing assembly 10 generally comprises a base 12 comprising a slicing portion 14 of the base 12 coupled to and extending upwardly from a top 16 of a basal portion 18 of the base 12. The basal portion 18 of the base 12 may have a width and a length between 18 cm and 23 cm. Additionally, the basal portion 18 of the base 12 may have a height between 1 cm and 2.5 cm. The base 12 may be comprised of a rigid and food grade material.

A top surface 20 of the slicing portion 14 of the base 12 angles downwardly from a front 22 of the slicing portion 14 of the base 12 toward a rear 24 of the slicing portion 14 of the base 12 so the slicing portion 14 of the base 12 is wedge shaped. The front 22 of the slicing portion 14 of the base 12 may have a height between 2.5 cm and 5 cm. Additionally, the height of the slicing portion 14 of the base 12 proximate the rear 24 of the slicing portion 14 of the base 12 may decrease to a height between 13 mm and 19 mm. The slicing portion 14 of the base 12 may have a length between 10 cm and 185 cm. Further, the slicing portion 14 of the base 12 may have a width between 16 cm and 21 cm.

The rear 24 of the slicing portion 14 of the base 12 extends upwardly from the top surface 20 of the slicing portion 14 of the base 12 so the rear 24 of the slicing portion 14 of the base 12 forms a stop 26. The top surface 20 of the slicing portion 14 of the base 12 may support a food item 28. The food item 28 is positionable on the top surface 20 of the slicing portion 20 of the base 12 so the food item 28 abuts a front 25 of the stop 26. Additionally, the stop 26 retains the food item 28 on the top surface 20 of the slicing portion 20 of the base 12. The food item 28 may comprise a block of cheese 29 or the like.

A plurality of grooves 30 extends downwardly into the top surface 20 of the slicing portion 20 of the base 12. The grooves 30 are parallel and each of the grooves 30 extends between the front 22 and the rear 24 of the slicing portion 20 of the base 12. The grooves 30 are evenly distributed between a first lateral side 32 and a second lateral side 34 of the slicing portion 20 of the base 12. Each of the plurality of grooves 30 may have a depth between 2 cm and 4.5 cm. Additionally, each the grooves 30 may have a width between 3 mm and 5 mm such that the plurality of grooves 30 is spaced apart a distance between 3 mm and 5 mm.

A pair of cutting members 36,66 is provided. Each cutting member 36,66 comprises a frame 68 having respective first lateral sections 38 and second lateral sections 40 that are each coupled to and extend between each of a respective rear section 42 and a front section 44 of the cutting member 36,66. Each cutting member 36,66 has a rectangular shape that may have a width and a length between 18 cm and 23 cm. Each of the first lateral 38, second lateral 40, front 44 and rear 42 sections of each cutting member 36,66 has a tubular shape with a radius that may be between 8 mm and 10 mm.

A pair of spaced retainers 48 is coupled to the top 16 of the basal portion 18 of the base 12 proximate a rear 50 of the basal portion 18 of the base 12. The rear section 42 of each cutting member 36,66 is removably and hingedly coupled to each of the spaced retainers 48. As can be seen in the drawings, each retainer 48 includes an arm and a gap such that the rear section 42 of each cutting member 36,66 is insertable through the gap such that the arm retains the cutting member 36,66 allowing the cutting member 36,66 to be pivoted as needed. Each cutting member 36,66 is removable by pulling the rear section 42 back out of the retainer 48 through the gap. Thus, the cutting members 36,66 are interchangeably couplable to the base 12. The cutting member 36 is positionable in an extended position such that the cutting member 36 extends upwardly from the base 12. The cutting member 36 is positionable in a cutting position so the front section 44 of the cutting member 36 abuts the top 16 of the basal portion 18 of the base 12 proximate a front 52 of the basal portion 18 of the base 12.

A front one 54 and a rear one 56 of couplers is each coextensively coupled to an associated one of the front 44 and rear 42 sections of the cutting member 36. Each cutting member 36,66 has a respective one of a first plurality of spaced slicers 58 and a second plurality of spaced slicers 78 that are evenly distributed between the first lateral section 38 and the second lateral section 40 of the respective cutting member 36,66. Each slicer 58 may comprise a wire between 28 AWG and 32 AWG. The slicers 58,78 of each cutting member 36,66 are spaced to correspond to and be received into an associated one of the grooves 30 when each cutting member 36,66 is coupled to the base 12. The slicers 58 may be spaced apart a distance between 5 mm and 7.5 mm on a first one of the cutting members 36 while the slicers 58 may be spaced apart a distance between 11.5 mm and 14 mm on a second one of the cutting members 66. The spacing of the slicers 58 on the second one of the cutting members 66 may be a whole unit multiple of the spacing of the slicers 58 on the first one of the cutting members 36. Each of the slicers 58 of the cutting member 36,66 coupled to the base 12 passes through the food item 28 as the cutting member 36,66 coupled to the base 12 is pivoted wherein each slicer 58 extends downwardly into the associated one of the grooves 30 when the cutting member 36,66 is positioned in the cutting position. Thusly, the food item 28 is sliced into a plurality of slices sized according to which cutting member 36,66 is employed.

In use, a selected one of the cutting members 36,66 is removably and hingedly coupled to the pair of spaced retainers 48. The cutting member 36,66 is selected based on the desired width of slices for the food item 28. The food item 28 is positioned on the slicing portion 14 of the base 12 so the food item 28 extends laterally across the slicing portion 14 of the base 12 and abuts the front 25 of the stop 26. The selected cutting member 36,66 is pivoted into the cutting position to slice the food item 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A slicing assembly for slicing a plurality of slices in a single motion, said assembly comprising:
a base configured to be positioned on a support surface wherein a food item is positionable on a top of said base;
a plurality of cutting members, said cutting members being interchangeably coupled to said base such that a selected one of said cutting members is movably coupled to said top of said base; and
each said cutting member having a respective plurality of slicers, said slicers of each cutting member being uniquely spaced relative to each other cutting member wherein each cutting member is configured for slicing food in an associated thickness when said cutting member is moved downwardly toward said base.

2. The assembly according to claim 1, further comprising said base comprising a slicing portion of said base coupled to and extending upwardly from a basal portion of said base.

3. The assembly according to claim 2, further comprising a top surface of said slicing portion of said base being angled downwardly from a front of said slicing portion of said base toward a rear of said slicing portion of said base wherein said slicing portion of said base is wedge shaped.

4. The assembly according to claim 3, further comprising a plurality of grooves extending downwardly into said top surface of said slicing portion of said base, each of said grooves extending between said front and said rear of said slicing portion of said base.

5. The assembly according to claim 4, further comprising said grooves being evenly distributed between a first lateral side and a second lateral side of said slicing portion of said base.

6. The assembly according to claim 1, further comprising said cutting member comprising a first and a second lateral section of said cutting member each coupled to and extending between each of a rear and a front section of said cutting member wherein said cutting member has a rectangular shape.

7. The assembly according to claim 6, further comprising said rear section of each said cutting member being hingedly coupled to said base proximate a rear of said basal portion of said base when said cutting member is coupled to said base.

8. The assembly according to claim 7, further comprising each said cutting member being positionable in an extended position such that said cutting member extends upwardly from said base, each said cutting member being positionable in a cutting position where said front section of said cutting member abuts a front of said basal portion of said base.

10. The assembly according to claim 1, further comprising each of said slicers being coupled between a rear section and a front section of said associated cutting member.

11. The assembly according to claim 10, further comprising said slicers being evenly distributed between a first lateral section and a second lateral section of said associated cutting member wherein each of said slicers is aligned with an associated one of a plurality of grooves extending into a top surface of a slicing portion of said base.

13. A slicing assembly for slicing a plurality of slices in a single motion, said assembly comprising:
a base comprising a slicing portion of said base coupled to and extending upwardly from a basal portion of said base, a top surface of said slicing portion of said base angling downwardly from a front of said slicing portion of said base toward a rear of said slicing portion of said base wherein said slicing portion of said base is wedge shaped wherein said top surface of said slicing portion of said base is configured to support a food item;
a plurality of grooves, each of said grooves extending downwardly into said top surface of said slicing portion of said base such that each of said grooves extends between said front and said rear of said slicing portion of said base, said grooves being evenly distributed between a first lateral side and a second lateral side of said slicing portion of said base;
a plurality of cutting members, each said cutting member comprising respective first and second lateral sections coupled to and extending between respective rear and front sections of said cutting member such that each said cutting member has a rectangular shape, said rear section of each said cutting member being hingedly couplable to said base proximate a rear of said basal portion of said base wherein said cutting members are interchangeably couplable to said base, each said cutting member being positionable in an extended position such that said cutting member extends upwardly from said base, each said cutting member being positionable in a cutting position where said front section of said cutting member abuts a front of said basal portion of said base; and
a plurality of slicers, each of said slicers being coupled an associated one of said cutting members, said slicers being coupled to said associated one of said cutting members between said rear section and said front section of said associated cutting member, said slicers being evenly distributed between said first lateral section and said second lateral section of said associated cutting member wherein each of said slicers is aligned with an associated one of said grooves when said associated cutting member is coupled to said base wherein each of said slicers is configured to pass fully through the food item and be received into the associated one of said grooves wherein the food item is sliced into a plurality of slices when said associated cutting member is positioned in said cutting position.
